(19) United States
(12) Patent Application Publication
(10) Pub. No.: US 2018/0276731 A1
(43) Pub. Date: Sep. 27, 2018

(54) System and Method for Automated Product Recommendations

(71) Applicant: Abzooba, Inc., Milpitas, CA (US)

(72) Inventors: Labhesh Patel, Santa Clara, CA (US); Pierre-Eric Melchy, San Jose, CA (US); Rajiv Pratap, San Jose, CA (US); Ihor Herasymchuk, San Jose, CA (US)

(21) Appl. No.: 15/469,316

(22) Filed: Mar. 24, 2017

(51) Int. Cl. G06Q 30/06; G06F 3/0486; G06T 7/10; G06F 3/0484; G06F 3/0487

(52) U.S. Cl. CPC G06Q 30/0631; G06Q 30/0603; G06Q 30/0641; G06F 3/0486; G06T 2207/30176; G06F 3/04842; G06F 3/0487; G06T 2207/20081; G06T 2207/20092; G06T 7/10

(57) ABSTRACT

A computer-implemented method for automated product recommendations personalized to a user browsing a webpage of an e-commerce website or web application via a computer device. Image data of one or more product items displayed on the webpage is captured responsive to user input, and then sent to a server over a network. A software module that executes on the server analyzes the image data and segments it into one or more of attributes, constituent items, or objects of the one or more product items. The software module also receives media content feeds that contain images representative of style preferences of the user. The software module selects one or more specific items from a product catalogue of the e-commerce website or web application based, in part, on a visual similarity to the images representative of the style preferences of the user.

### TECHNICAL FIELD

The present disclosure relates generally to the field of cloud computing; more particularly, to computer vision systems and methods for automated processing, analyzing and understanding digital images on websites, mobile applications, and cloud-based applications.

### BACKGROUND

Electronic commerce, also known as eCommerce, continues to grow as more people purchase goods and services online over the Internet. Brands, website owners, and businesses engaged in e-commerce are understandably interested in optimizing the performance of their website in order to increase revenue. This has led to the development of a variety of tools including targeted advertising and dynamic, content based on a person's previous purchases, behaviors, interests or demographics. Other tools provide business analytics that helps a website owner improve the digital performance of their website in order to increase conversions. A conversion happens when a person who browsing a website or application converts to being a user or buyer of a service or product that website or application offers. Conversions, understandably, are the lifeblood of an online business.

For many companies, every visitor to their website sees the same articles, offers and images, regardless of who they are or how they've interacted with that company in the past. Other companies attempt to deliver more personalized Web content which is allowed to evolve based on visitor interactions and activity. For example, a visitor's previous purchase or download may provide a starting point for a content management system that can pull in data from a marketing database, then display images and product offers based on the visitor's previous behaviors.

One of the problems faced by website designers and engineers is how to go about making intelligent product recommendations that are personalized to a visitor to an eCommerce site. Conventional approaches typically focus on demographics, previous search history and purchases when making recommendations for future purchases. For instance, if a visitor to a website previously purchased a shirt, the next time that person visits the same website, relevant dynamic content the retailer might display product recommendations for similar shirts, or items bought by persons who also bought that same shirt. When making product suggestions the difficulty is often in understanding the visitor's very personal likes and dislikes, many of which are not capable of being clearly articulated.

### BRIEF DESCRIPTION OF THE DRAWINGS

The present disclosure will be understood more fully from the detailed description that follows and from the accompanying drawings, which however, should not be taken to limit the invention to the specific embodiments shown, but are for explanation and understanding only.

FIG. 1 is an example high level architectural diagram of a system for making automated product recommendations that are personalized to a specific website visitor.

FIG. 2 is an example graphical user interface window that shows a product page of a retail website.

FIG. 3 is an example block diagram showing various components utilized for making personalized product recommendations for a website visitor.

FIG. 4 is an example flow diagram of a method for automated generation of one or more product recommendations for a website visitor.

### DETAILED DESCRIPTION

In the following description specific details are set forth, such as data analysis platforms, method steps, algorithms, devices, etc. in order to provide a thorough understanding of the subject matter disclosed herein. However, persons having ordinary skill in the relevant arts will appreciate that these specific details may not be needed to practice the present invention. It should also be understood that the elements in the FIGS. are representational.

References throughout this description to “one embodiment”, “an embodiment”, “one example” or “an example” means that a particular feature, structure or characteristic described in connection with the embodiment or example is included in at least one embodiment. The phrases “in one embodiment”, “in an embodiment”, “one example” or “an example” in various places throughout this description are not necessarily all referring to the same embodiment or example. Furthermore, the particular features, structures or characteristics may be combined in any suitable combinations and/or sub-combinations in one or more embodiments or examples.

In the context of the present application, the term “cloud” broadly refers to a collection of machine instances, storage and/or network devices that work together in concert. The term “cloud computing” refers to a paradigm in which machine storage, and application resources exist on a “cloud” of servers. In cloud computing shared resources, software and information are provided on-demand, like a public utility, via the Internet. Thus, cloud computing provides computation, data access, and storage resources without requiring users to know the location and other physical details of the computing infrastructure.

The term “server” broadly refers to any combination of hardware or software e bodied in a computer designed to provide services to client devices or processes. A server therefore can refer to a computer that runs a server operating system from computer-executable code stored in a memory, and which is provided to the user as a virtualized or non-virtualized machine; it can also refer to any software or dedicated hardware capable of providing computing services. A web server is an information technology that processes requests via HTTP, the basic network protocol used to distribute information on the World Wide Web. A webpage is a web document that is suitable for the World Wide Web. A web browser running on a client or user computing device displays a web page on a monitor or mobile device screen.

In the context of the present, disclosure a “mobile computing device” “mobile device” (for short) refers to any one of a number of different portable electronic devices having a touch-sensitive display with a graphical user interface (GUI), one or more processors, memory and one or more modules, programs or sets of instructions for performing methods associated with the operations described herein. A mobile computing device typically runs on an operating system executed on one or more processors, and may also run one or more applications installed or resident in memory (e.g., firmware, RAM, EEPROM, etc.) In some embodiments, the mobile computing device may provide a plurality of functions including wireless communication, thereby allowing a user of the mobile device access data and information via connection to the Internet. Mobile computing devices include smartphones, tablet computers, wearable computers, ultra-mobile PCs, personal digital assistants, other hand-held devices, as well as other mobile computers (e.g., carputers) that have touch screen interfaces with wireless capabilities.

A “landing page” is any webpage on a website that serves as the initial point of entry for a user to the website. The landing page is typically the homepage, and is commonly accessible by clicking on a hyperlink on another web page, by clicking on a search engine search result, or by inputting a Hypertext Transfer (or Transport) Protocol (HTTP) address of a website to a browser application. Other types of common landing pages include category pages, which typically serve as product overview pages that link to an individual service, product or Stocking Keeping Unit (SKU) page and product pages, where you see SKU or service details, and where visitor can add an item to a shopping cart.

A “mouseover” or “mouse hover” is computer function in which one or more images or hyperlinks can be generated or activated when a user moves or “lovers” the cursor or pointer over a graphical hover area or trigger area of a web browser window (e.g., rollover window), usually with a mouse, but also possible using a digital pen or touch command. Mouseover events are not limited to web design and are commonly used in modern graphical user interface programming.

The term “real-time” refers to a level of computer responsiveness that a user senses as sufficiently immediate or that enables the computer to keep up with some external process (for example, to present visualizations of computed results). Thus, real-time is a mode of computer operation in which the computer collects data, analyzes or computes with the data, reports (e.g., visually displays) and/or stores the results nearly instantaneously, i.e., within a few seconds or less (milliseconds).

In the context of the present disclosure, a “widget” is an element of interaction in a graphical user interface (GUI), such as a button, icon, dialog box, pop-up window, pull-down menu, scroll bar, selection boxes, etc., that allows a user to interface with the application and operating system. The term widget also refers to the computer program that is written in order to make the graphic widget in the GUI look and perform in a specified manner, depending on what action the user takes while interfacing with the GUI. The term widget therefore may be used to refer to either the graphic component or its controlling program, or refer to he combination of both.

Computer vision an engineering field that deals with how computers can extract high-level information from digital images or videos, often with the goal of automating tasks that the human vision system can perform. These tasks typically include methods for acquiring, processing, analyzing and understanding digital images. Computer vision typically deals with extraction of high-dimensional data from the real world to produce information that may be in the forms of decisions. Deep learning is a branch of machine learning in which computers gain the ability to learn without being explicitly programmed based on a set of algorithms that attempt to model high level abstractions in data. Deep learning is part of a broader family of machine learning methods based on learning representations of data.

In one embodiment, a system method and computer program product is provided for allowing an e-commerce website to utilize a widget that connects to one or more personalized social media feeds responsive to user input. The social media feeds may include blogs, photo-sharing application feeds such as Instagrm feeds personal feeds of designers and/or celebrities, or other media feeds that include images or videos that reflect or represent a user's personal likes and preferences. In one example, the users personal likes and preferences pertain to the fields of fashion and style. In one embodiment the user is given the ability to sort through the images displayed in the feeds and select or designate images or videos that the person likes or finds appealing.

In one embodiment, responsive to a mouseover event when a user positions a cursor or pointer over a selected image on a product page of a retail website, a copy of that image is sent to a remote server. The remote server, upon receiving the image, segments the image into various constituent objects. For example, in the case where the user selects a particular product page image of a model wearing a number of items, the backend server segments the image into each of the detected constituent items or objects, e.g., shirt, pants, jacket, sun glasses, watch, shoes, etc. After segmentation and object detection, a software module or widget goes through the e-commerce site's product catalog and finds products that are visually similar to the detected segments or objects. That is, the program running on the remote server utilizes computer vision software to search through the retailer's product catalogue and select those items which most closely correspond to, the detected segments/objects found in the user's selected image.

In another embodiment instead of a mouseover event, a touch event may be utilized to trigger the sending of a copy of the image the user touches to a remote server. For example, a user of a mobile computing device that has a touch screen graphical user interface may touch a picture of image of a product when browsing a website or mobile app, which input, in turn, initiates the automated generation of one or more recommendations for products available on the website or mobile app.

In one embodiment, the software module, or a separate software module, may be used to rank the various product items according to a ranking criteria or algorithm, and then display them to the user as the user continues browsing the website or webpage. In one implementation the ranking criterion includes a similarity score between the objects detected in the image and objects present in the retailer's online product catalogue. In another embodiment, a ranking algorithm may include the popularity of the product being shown. In still another embodiment, the ranking may include the style preferences learned from the user's selected social media feeds.

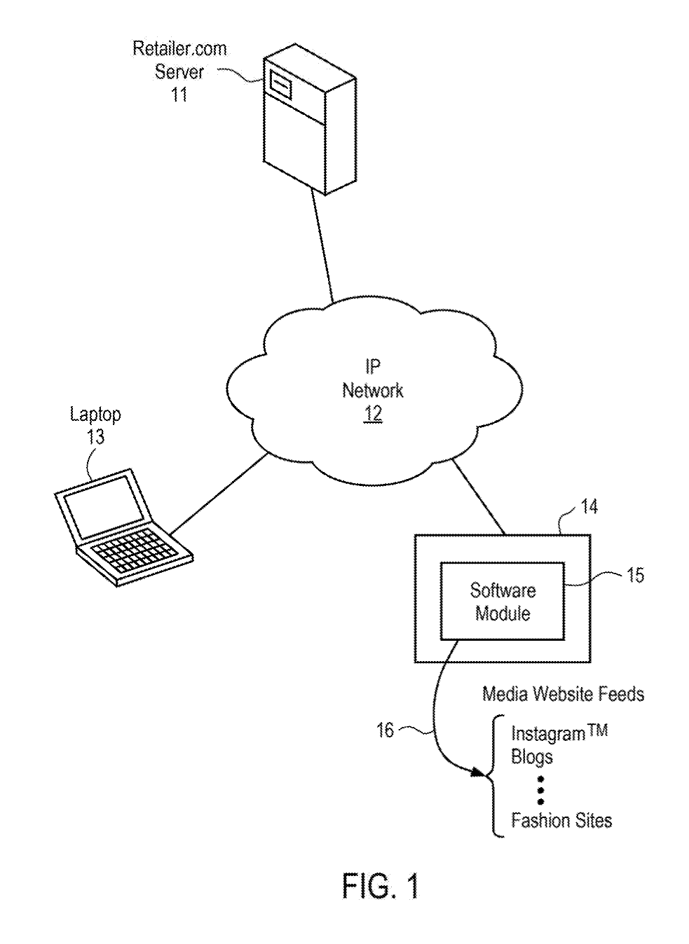

FIG. 1 is an example high-level architectural diagram of a system for making automated product recommendations that are personalized to a specific website visitor or user. As shown, the system includes a website server 11 associated with a retailer (Retailer.com) connected via a cloud 12 with a laptop computer 13 and a backend or remote server 14. Cloud 12 may comprise an Internet Protocol (IP) network, such as the general public Internet, or an intranet, private computer network confined to an organization that uses IP technology or a combination of private and public networks. Laptop computer 13 may alternatively comprise one, or more computing devices, including mobile devices, desktop computers, or any other computing device that is configured to accept user input, communicate with servers 11 and 14, navigate through the website or web application, and display images, text, results, etc. Similarly, server 11 shown in FIG. 1 may comprise a single server (as shown) or a plurality of servers, either located at a single center or distributed across different geographical locations.

In the embodiment shown, a product recommendation software module 15 resides on remote server 14. Software module 15 comprises a computer program that executes on server 14, with links 16 to one or more media sites or databases. In one embodiment, the user may personalize links 16: for instance, choosing which Instagram handles or blogs to follow, based on the user's personal tastes and preferences. When the user of laptop 13 positions the cursor over a product image on his display screen when browsing on the retailer's website, the mouseover event triggers the sending of the underlying image to software module 15. Deep learning models within software module 15 analyze the image.

Taking the image as input, and based on the user's personal preferences as indicated by the user's preferences represented in their personalized links 16, the deep learning model searches the retailer's product catalogue to determine which items in the catalogue most closely match the user's preferences. In one embodiment, a list or set of images is generated which are visually similar to the selected or moused over image. The list may be automatically displayed to the user responsive to the mouseover event. In another embodiment, the list is stored and the user is a alerted to the additional products selected by the deep learning model. For example, a message such as, “Click here to view other items you might like” may appear on the display screen of laptop 13, thereby allowing the user to view the automatically generated list of product selections at their leisure. Thus, the automated software module provides a customized or personalized shopping experience closely tailored to his or her likes and style preferences.

In another embodiment, the functionality provided by server 14 and software module 15 may be incorporated into retail server 11.

It is appreciated that in other embodiments, the computer program that executes ware module 15, or portions thereof, may be downloaded to execute on laptop 13. Links 16 to one or more media content websites may be accessed by server 11 and/or laptop 13. Server 11 communicates with laptop 13 via a browser application running on laptop 13.

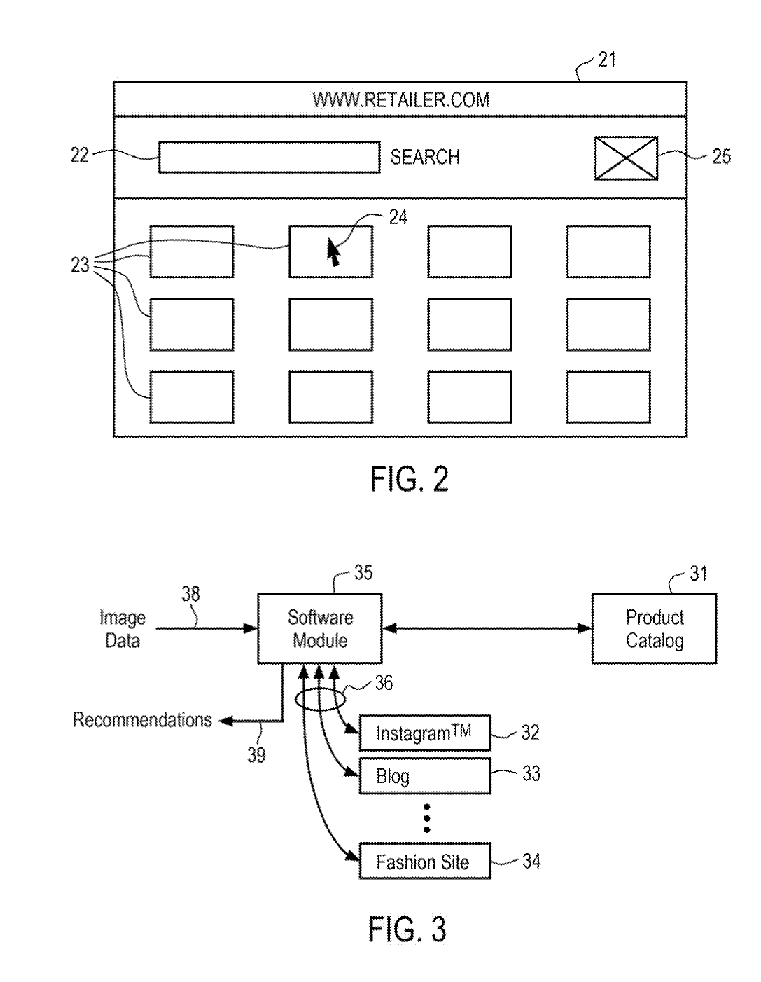

FIG. 2 is an example graphical user interface window 21 that shows a product page of a retail website As shown, window 21 includes a search field 22 where a user may enter a product number, name, or keyword which results in a plurality of product image frames 23 being generated in a lower area of window 21 that correspond to the search input. For example, if the user entered “men's jacket” in search field 22, a plurality of images 23 may be generated of all the different jackets in the retailer's product catalogue. It is appreciated that there may be dozens or hundreds of items returned in response to the search phrase “men's jacket”.

In the example of FIG. 2 the user has positioned the cursor 24 over one of the jacket image frames 23 that the user is interested in. In one embodiment, this mouseover event triggers the deep learning model in the software module, represented by box 25, to analyze the image to find all of the various attributes of the jacket, e.g., texture, material, cut, color, style, brand, etc. In one embodiment the system asks the user to identify the specific attribute (e.g., color, style, texture etc.) that is to be used to trigger the similarity search.

Using the links to the user's personalized media feeds, the software module may determine that the user finds inspiration in the clothes of a particular male celebrity, or blogs and specific fashion sites. Using the product image as initial input, and determining the user's preferences and styles of jackets via the user's personalized media links, the deep learning model is able to recommend items from the retailer's product catalogue which are similar to or match his preferences and styles. That is, the recommendations are based on the person's likes/interests as expressed via s links to various media sites, blogs, Instagram, fashion websites, etc. The software module assists the user in his product searches by making a connection between where the user finds fashion inspiration and which products on a particular retailer website most closely match his personal style preferences.

In one embodiment, software module 25 runs invisibly in the background to automatically display a set of similar or matching products responsive to a mouseover event. In another embodiment, an icon or trigger area is designated in window 21 for triggering software module 25 to perform an analysis and then display similar or matching items. For instance, the user may select or click on a particular product image and then mouseover or click on an icon or trigger area to perform the backend analysis and product recommendations.

In still another embodiment, the GUI running on the widget may be configured to allow the user to browse any website and drag-and-drop a selected product image to a sidebar area. In response, product recommendation results are automatically generated by the system and appear on an area of the browser screen (e.g., in the sidebar area). Thus, a single drag-arid-drop step can initiate the analysis and product catalogue searching operations that generate customized product recommendations for the user. Persons of skill in the art will appreciate that this enables a user to search recommended product images without leaving the product page they are browsing. In one embodiment, this feature may be provided as a browser plugin.

The widget may also be configured to enable a user to see view customized product recommendations based on a video that the user is watching. For instance, an extension on the browser may send video frames to the backend server, which segments the images by attributes and returns similar product recommendation results. This can occur either in real-time and/or non-real-time. Real-time results may populate the display screen while the user is watching the video. Non-real-time results may be based on statistical analysis of one or more videos that the user has viewed within a specified time period. In one implementation, after the specified time period expires, a push notification may be sent to the user's computer device or to an application (e.g., email client, messaging app, pop-up window of the user's browser) that runs on the user's device.

In the event that the product image selected or moused over contains multiple items available for sale, e.g., jacket, pants, belt, etc., software module 25 may generate multiple lists of product recommendations, one list for each item analyzed.

In one embodiment, the GUI allows a user to graphically “paint” a boundary around the object from the image that he or she is browsing. The software module then isolates the specific object and forks off a backend search as discussed above. In another embodiment, the user may paint a similar object across different ages present in product image frame 23. The software module then isolates these specific objects and forks off a backend search using this set of objects as discussed above.

In another embodiment, the e-commerce website software module captures and stores the various product image frames that a user clicks on and automatically creates a persona that is stored in a memory or database for the user based on the user's selections. The website may user the stored persona information to send personalized recommendations to the user. The recommendations may be generated in either real-time or non-real-time communication to the user. In one embodiment, the persona information created for the user may be used to personalize the user's image feed provided via the links to third party media content sites.

In another embodiment, the GUI allows a user to create an e-wardrobe on an e-commerce site by selecting various objects from different images. In yet another embodiment, the GUI allows an e-commerce website to use the e-wardrobe information of various users in making purchase and inventory decisions for their supply chain.

In still, another embodiment, the GUI allows a user to provide voice command input. For instance, a user may provide voice input commands while viewing an image feed of product recommendations, or to indicate user likes and preferences. For example, during or after watching an image showing a particular item of a celebrity, a user might say, “I like the jacket”. The e-commerce endpoint (web or mobile) may use this speech input to rank the objects that are displayed to the user once the object segmentation and the backend visual search has produced candidate product recommendations.

In yet another embodiment, the computer program is configured to provide ensemble generation from an image provided by the user; that is, to make recommendations of products that are present in a selected or mouseover image. In addition, the software may be configured to make recommendations for products that are not in the image, but which relate to the product in the image, and which match well with those articles based on the user preferences and styles reflected in the user's persona, and/or links to media content'feeds. By way of example, a user may hover over a pair of pants, which triggers additional pants product recommendations but also triggers recommendations for other items, such as belts, shoes, shirts, etc., that compliment or go with the pants recommendations.

Voice and speech recognition software may also be incorporated in the software module to allow the user to comment on the product recommendations and refine or modify the product recommendations. For example, if the user mouses over an image of a bedside table, resulting in a set of additional table recommendations, the user may utilize voice commands to request a different color (“show tables that,are tan in color”), shelving options (“show tables with magazine shelves”), or other features (“show tables with rounded edges”).

In one embodiment, rather than mousing over a particular product image and making product recommendations based on the information obtained through the user's customized links to various media sites, the user may generate a product recommendation for an item or ensemble through user input alone. That is, the user may provide input to the system, e.g., via voice commands or text, regarding what it is they would like to search for. In response, the product recommendation widget system creates a mock-up image of the desired item, which the user may refine further. Once the user is satisfied, the image can be sent to the remote server to generate an appropriate product recommendation. For example, the user may be looking for a bedside table tan in color, with a shelf to store magazines. In response to this input, the system creates a mock-up image of the desired item. The user may edit the image with further user interface input, e.g., the user could say, “Make the color a darker shade of tan”.

FIG. 3 is an example block diagram showing various components utilized for making personalized product recommendations for a website visitor. As shown, software module 35 is configured to receive image data 38 sent from a GUI running on the user's browser. In one embodiment, the sending of the image data may be triggered by a single mouseover event, where the user positions the cursor over a product image the user is viewing on a particular website or web application.

In response to receiving the image data, software module analyzes the image and then determines the users style preferences for the item(s) or objects present in the image data via links 36 connected to various media content site feeds. By way of example, FIG. 3, shows feeds to Instagram 32 blog 33, and fashion site 34. Using the information obtained through links 36 to the user's customized feeds, software module searches the website's product catalogue 31 for item s that most closely match the users style preferences. The similar or closely matched items are then returned as product recommendations. In one embodiment, images of the recommended products are displayed on the display screen of the user's client device (e.g., laptop, mobile device, smartphone, tablet, etc.).

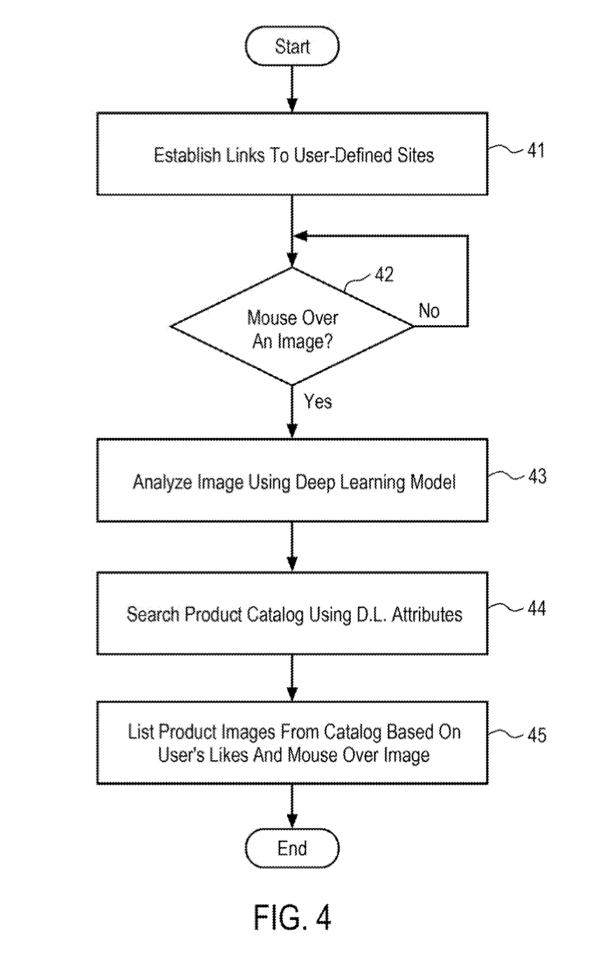

FIG. 4 is an example flow diagram of a method for automated generation of one or more product recommendations for a website visitor. The first step in the process is the establishment, by the widget, of one or more links to the user-defined sites that contain data/information regarding the user's likes, dislikes, and various style preferences. (Block 41) Note that this information may be in the form of images that the user has indicated he or she likes and/or dislikes. A query is performed next to determine whether the user has moused over an image on a product page of the website that he or she is navigating through. (Block 42) If a mouseover event has occurred, a digital image of the selected item is automatically sent to a backend server (or the website server) where it is analyzed by a software module that includes a deep learning model. (Block 43)

It is appreciated that other types of user input, may also be used in the determination that triggers the sending of the image to the software module. In another embodiment, the step that establishes the links to the user-defined sites may occur responsive to the mouseover event, not before. In another embodiment, instead of a mouseover event, a mock-up image may be created through user input that describes the product item the user is seeking, the input included details of various features the user desires.

The analysis of the received image utilizes a deep learning model to first segment the image into its constituent objects, attributes and features, e.g., a long sleeve, buttoned, collared dress shirt. Based on the data feed links established previously which may provide specific examples of long sleeve buttoned, collared shirts that the user likes or which express their style/design/fashion preferences, the deep learning model searches the product catalogue of the website that the user is browsing for shirts that closely match the user's preferences. (Block 44) The resulting list of items in the product catalogue that are similar or most closely match the user's preferences is returned to the user's client device. (Block 45) In one embodiment, the list appears in a browser window on the display screen of the client device in the form of a set of product images taken from the catalogue.

It should be understood that elements of the, disclosed subject may also be provided as a computer program product which may include a machine-readable medium having stored thereon instructions which may be used to program a computer (e.g., a processor or other electronic device) to perform a sequence of operations, such as those described above. Alternatively, the operations may be performed by a combination of hardware, firmware, and software. The machine-readable medium may include, but is not limited to, floppy diskettes, optical disks, CD-ROMs, and magneto-optical disks, ROMs, RAMs, EPROMs, EEPROMs, magnet or optical cards, or other type of machine-readable medium suitable for storing electronic instructions.

Additionally, although the disclosed subject matter has been described in conjunction with specific embodiments, numerous modifications and alterations are well within the scope of the present invention. For instance, although examples have been described for use in making customized product recommendations for a user navigating to a website, the disclosed widget also applies to mobile apps, chat hots, and other types of delivery mechanisms. Accordingly, the specification and drawings are to be regarded in an illustrative rather than a restrictive sense.

We claim:

1. A computer-implemented method for automated product recommendations personalized to a user browsing a webpage of an e-commerce website or web application via a computer device, the computer-implemented method comprising:
responsive to user input, capturing image data of one or more product items displayed on the webpage;
receiving, by a server,the image data sent from the computer device over a network;
analyzing, by a software module that executes on the server, the image data to segment the image data into at least one or more of attributes, constituent items, or objects of the one or more product items;
receiving, by the software module, one or more media content feeds from corresponding one or more third party websites or applications, the one or more media content feeds containing images representative of style preferences of the user; and
selecting, by the software module, one or more specific items from a product catalogue of the e-commerce website or web application, the one or more specific items including at least a portion of the one or more attributes, constituent items, or objects, selection of the one or more specific items being based on a visual similarity to the images representative of the style preferences of the user.

2. The computer-implemented method of claim 1 further comprising sending a digital image of each of the one or more specific items to the computer device of the user for display thereon.

3. The computer-implemented method of claim 1 wherein the user input comprises a mouseover event.

4. The computer-implemented method of claim 1 wherein the user input comprises touch event.

5. The computer-implemented method of claim 1 wherein the user input comprises a voice command.

6. The computer-implemented method of claim 1 wherein the user input comprises a drag-and-drop event in which an image of the one or more product items is moved to a sidebar area of a browser window.

7. The computer-implemented method, of claim 6 wherein the analyzing, the receiving of the one or more media content feeds, and the selecting of the one or more specific items occurs automatically responsive to the drag-and-drop event.

8. The computer-implemented method of claim 1, further comprising ranking the one or more specific items according, to a ranking criteria.

9. The computer-implemented method of claim 8 wherein the ranking occurs responsive to additional user input.

10. The computer-implemented method of claim 2 further comprising displaying, on a screen of the computer device, the digital image of each of the one or more specific items in real-time responsive to the user input.

11. The computer-implemented method of claim 1 wherein the one or more media content feeds include at least one social media feed.

12. The computer-implemented method of claim 1 wherein the server comprises a retailer server of the e-commerce website or web application.

13. The computer-implemented method of claim 1 wherein the server comprises a remote server of a third party service.

14. The computer-implemented method of claim 1 wherein the user input comprises a graphical input that creates a boundary around the of one or more product items displayed on the webpage.

15. The computer-implemented method of claim 1 further comprising selecting, by the software module, one or more additional items from the product catalogue of the e-commerce website or web application, the one or more additional items not including, but which relate to, the one or more attributes, constituent items, or objects of the segmented image data.

16. The computer-implemented method of claim 1 wherein the analyzing is performed by a deep learning model of the software module.

17. A non-transitory computer-readable storage medium encoded computer instructions, which, when executed by one or more processor operable to:
capture responsive to user input, image data of one or more product items displayed on the webpage;
receive, by a server, the image data sent from the computer device over a network:
analyze, by a software module that executes on the server, the image data to segment the image data into at least one or more of attributes constituent items, or objects on the one or more product items;
receive, by the software module, one or more media content feeds from corresponding one or more third party websites or applications, the one or more media content feeds containing images representative of style preferences of the user; and
select, by the software module, one or more specific items from a product catalogue of the e-commerce website or web application, the one or more specific items including at least a portion of the one or more attributes, constituent items, or objects, selection of the,one or more specific items being based on a visual similarity to the images representative of the style preferences of the user.

18. The non-transitory computer-readable storage medium of claim 17 wherein execution of the computer instructions is further operable to send a digital image of each of the one or more specific items to the computer device of the user for display thereon.

19. The non-transitory computer-readable storage medium of claim 17 wherein execution of the computer instructions is further operable to rank the one or more specific items according to a ranking criteria.

20. The non-transitory computer-readable storage medium of claim 17 wherein the user input comprises a mouseover event.

21. The non-transitory core outer-readable storage medium of claim 17 wherein execution of the computer instructions is further operable to display, on a screen of the computer, device, the digital image of each of the one or more specific items in real-time responsive to the user input.
